(19) United States
(12) Patent Application Publication
(10) Pub. No.: US 2011/0069155 A1
(43) Pub. Date: Mar. 24, 2011

(54) Apparatus and method for detecting motion

(75) Inventors: Joon-kee Cho, Yong-si (KR); Yeon-ho Kim, Hwaseong-si (KR)

(73) Assignee: SAMSUNG ELECTRONICS CO., LTD., Suwon-si (KR)

(21) Appl. No.: 12/801,085

(22) Filed: May 20, 2010

(30) Foreign Application Priority Data
Sep. 18, 2009 (KR) 10-2009-0088633

(51) Int. Cl. H04N 13/02; G06K 9/00

(52) U.S. Cl. 348/47; 382/107; 348/E13.074

(57) ABSTRACT

An apparatus and method for detecting a motion using a stereo camera are provided. The apparatus can acquire an object image including only an object without a background using the stereo camera. The apparatus can set a motion detection area in the acquired object image and recognize an image change amount in the motion detection area to detect a motion of the object.

### CROSS-REFERENCE TO RELATED APPLICATIONS

This application claims the benefit under 35 U.S.C. §119(a) of Korean Patent Application No. 10-2009-0088633, filed on Sep. 18, 2009, the disclosure of which is incorporated herein in its entirety by reference.

### BACKGROUND

1. Field

One or more embodiments relate to detecting and recognizing motion of a person.

2. Description of the Related Art

A service providing system provides services desired by a user by recognizing presence and location of the user and a direction or type of motion of the user, which contributes to more convenient use of the system.

Examples of such a system include a secure entrance control system that recognizes a face of a visitor to the secure entrance, a notebook computer with a camera that senses a face of a user for log-in, and a camera that detects a face to capture a smile.

Recently, the motion of a user has also been detected using image information acquired from a camera mounted in a system.

In this case, motion of the user is recognized by calculating an optical flow obtained by detecting feature points from an image and tracking locations of the feature points.

This technology may be applied when a background image for the user is relatively simple or stationary, but not when the background image includes the same iterative patterns or a moving image (e.g., a television screen).

### SUMMARY

According to one or more embodiments, there is provided an apparatus for detecting a motion, including an object image acquiring unit acquiring object images using distance information for an object included in images obtained from at least two cameras, the object image including only the object without a background, a motion-detection-area setting unit setting a motion detection area in the acquired object image, and a motion detecting unit detecting a motion of the object based on an amount of an image change in the motion detection area between the acquired object images.

The object image acquiring unit may include a first image acquiring unit, a second image acquiring unit, a facial area detecting unit detecting a facial area from the image obtained from the first image acquiring unit or the second image acquiring unit, a distance image acquiring unit acquiring a distance image from the images obtained from the first image acquiring unit and the second image acquiring unit, and an image filtering unit producing the object image using the detected facial area and the acquired distance image.

The object image acquiring unit may include a first image acquiring unit, a second image acquiring unit, a facial area detecting unit detecting a facial area from the image obtained from the first image acquiring unit or the second image acquiring unit, a distance image acquiring unit acquiring a distance image from the images obtained from the first image acquiring unit and the second image acquiring unit, a mask creating unit creating an image mask using the detected facial area and the acquired distance image, and an image filtering unit producing the object image from the image obtained from the first image acquiring unit or the second image using the created image mask.

The motion detection area may be set around a face of the object. The image change amount may be defined as an optical flow between the images, or a location of a feature point or a distance change amount.

According to one or more embodiments, there is provided a method of detecting a motion, including acquiring object images using distance information for an object included in images obtained from at least two cameras, the object image including only the object without a background, setting a motion detection area in the acquired object image, and detecting a motion of the object based on an amount of an image change in the motion detection area between the acquired object images.

Additional aspects, features, and/or advantages of embodiments will be set forth in part in the description which follows and, in part, will be apparent from the description, or may be learned by practice of the disclosure.

### BRIEF DESCRIPTION OF THE DRAWINGS

These and/or other aspects and advantages will become apparent and more readily appreciated from the following description of embodiments, taken in conjunction with the accompanying drawings of which:

FIG. 1 illustrates a distance image, according to one or more embodiments;

FIG. 2 illustrates an acquiring of a distance image, according to one or more embodiments;

FIG. 3 is a block diagram of a motion detection apparatus, according to one or more embodiments;

FIG. 4 is a block diagram of an object image acquiring unit, according to one or more embodiments;

FIG. 5 is a block diagram of an object image acquiring unit, according to one or more embodiments;

FIG. 6 illustrates an operation of a motion detection method, according to one or more embodiments;

FIG. 7 illustrates an operation of a motion detection method, according to one or more embodiments; and

FIG. 8 is a flowchart illustrating a motion detection method, according to one or more embodiments.

### DETAILED DESCRIPTION

Reference will now be made in detail to embodiments, examples of which are illustrated in the accompanying drawings, wherein like reference numerals refer to like elements throughout. In this regard, embodiments of the present invention may be embodied in many different forms and should not be construed as being limited to embodiments set forth herein. Accordingly, embodiments are merely described below, by referring to the figures, to explain aspects of the present invention.

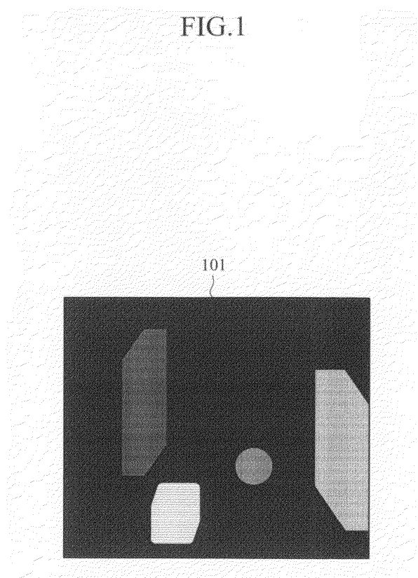

FIG. 1 illustrates a distance image, according to one or more embodiments.

In FIG. 1, the distance image 101 may be defined as an image in which respective points are represented by distance information. In the distance image 101, the distance information may be represented by colors or different shades of gray. For example, the respective points of the distance image 101 may be represented by colors or different shades of gray having different brightness depending on distances.

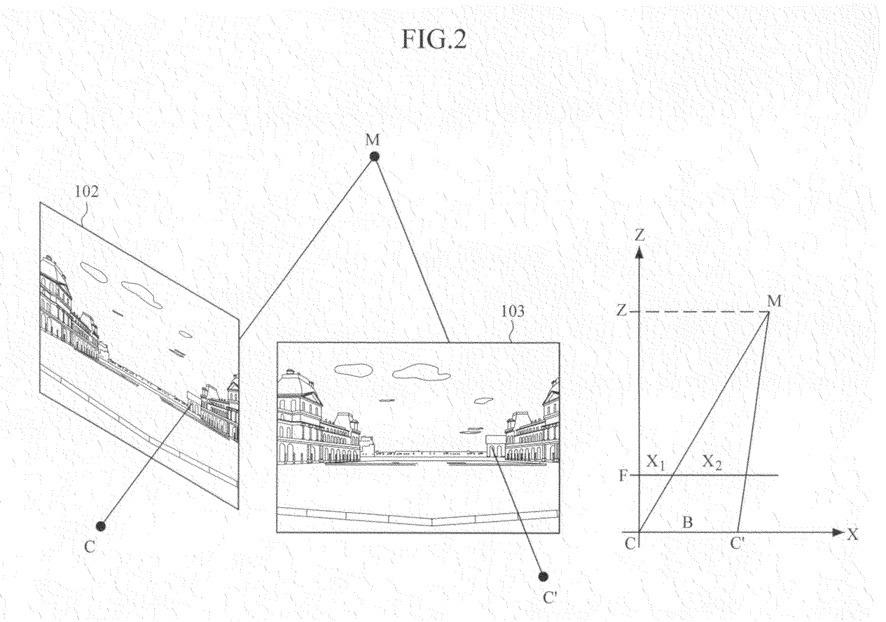

FIG. 2 illustrates an acquiring of a distance image, according to one or more embodiments.

In FIG. 2, the distance image may be obtained from first and second images 102 and 103, respectively acquired by left and right cameras of a stereo camera, for example. The stereo camera may have the left and right camera combined as in eyes of a person. For example, the left camera may be located at point C and the right camera may be located at point C′. In this case, a distance from the first image 102 or the second image 103 to a specific point M may be obtained by the below Equation 1, for example.

z=(B/d)*F Equation 1

In Equation 1, with regards to FIG. 2, z denotes the distance from the image to point M, B denotes a distance between point C and point C′, d denotes a difference between location coordinates of point M in the respective images (i.e., a difference between X₁ and X₂), and F denotes a focal length of a camera lens. B may be a constant or a measured value, d may be obtained using a sum of squared difference (SSD) scheme, and F may depend on the camera lens, as only examples. Based on the values, the distances z from each image to the specific point can be obtained.

Thus, the two images 102 and 103 may be acquired by the stereo camera, the distances of the respective points of the images are calculated, and the points are represented by different colors or shades of gray according to the distances, and thus a distance image such as shown in FIG. 1 can be acquired.

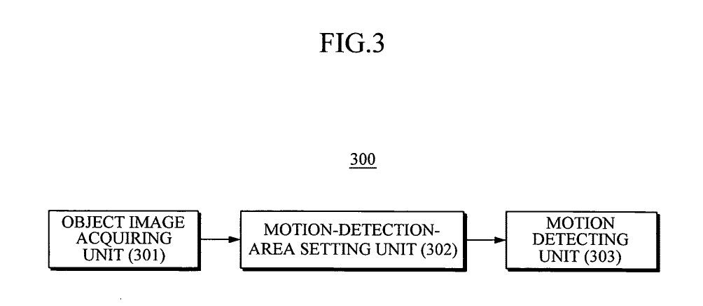

FIG. 3 illustrates a motion detection apparatus, according to one or more embodiments.

In FIG. 3, a motion detection apparatus 100 may include an object image acquiring unit 301, a motion-detection-area setting unit 302, and a motion detecting unit 303, for example.

The object image acquiring unit 301 may acquire an object image that is an image including only the object without a background, using distance information for an object included in images obtained from at least two cameras.

In an embodiment, the object image may include only an object by removing a background from any image including the background and the object. The object image may be acquired through facial area information and a distance image obtained based on the respective images obtained from the stereo camera, for example. In an embodiment, the object image may be obtained continuously at certain time intervals by the object image acquiring unit 301. That is, in such an embodiment, a first object image may be acquired at time t₀ and a second object image may be obtained at time t₁.

The motion-detection-area setting unit 302 sets a motion detection area in the acquired object image. The motion detection area may be a reference area for recognizing an amount of an image change between the first object image and the second object image. The motion detection area may be formed around a face in each object image, for example.

The motion detecting unit 303 recognizes an amount of an image change between the acquired object images to detect a motion of an object. For example, the motion detecting unit 303 may detect the motion of the object based on the image change amount in the motion detection area set in each of the first and second object images. In this case, the image change amount may be defined as an optical flow between images, a location of a specific feature point, or a distance change amount, for example.

The detected motion may include a type of the motion, such as a moving direction of a person's hand. The motion detection apparatus 300 may further include a motion controller generating a predetermined control command according to the motion detected by the motion detecting unit 303.

Thus, since the motion detection apparatus 300, according to an embodiment, acquires the first and second object images including only the object without a background at certain time intervals, sets the motion detection area around the face of each object image, and detects the motion of the object through the image change amount in the motion detection area, the motion detection apparatus 300 can detect the motion of the object with a limited amount of computation irrespective of a change of the background.

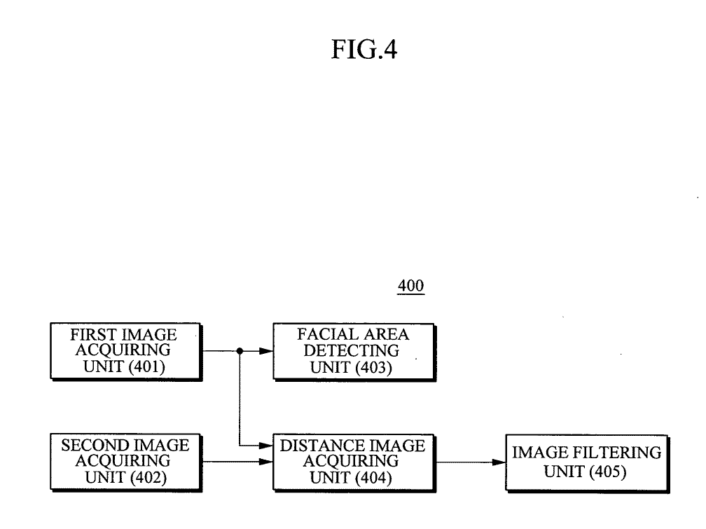

FIG. 4 is a block diagram of an object image acquiring unit, according to one or more embodiments.

Referring to FIG. 4, an object image acquiring unit 400 may include a first image acquiring unit 401, a second image acquiring unit 402, a facial area detecting unit 403, a distance image acquiring unit 404, and an image filtering unit 405, for example.

The first image acquiring unit 401 and the second image acquiring unit 402 may be a stereo camera that simultaneously photographs the same area. For example, the first image acquiring unit 401 may be a left camera of a stereo camera and the second image acquiring unit may be a right camera of the stereo camera, both being spaced a predetermined distance apart. For convenience of illustration, an image obtained by the first image acquiring unit 401 is referred to as an L image and an image obtained by the second image acquiring unit 402 is referred to as an R image.

The facial area detecting unit 403 detects a facial area from the L image. A variety of face detection algorithms, such as a boosted cascade scheme for a feature point, may be employed. For example, the facial area detecting unit 403 can detect the facial area by scanning a predetermined search window in the L image.

The distance image acquiring unit 404 may acquire a distance image using the L and R images. Here, the definition and acquisition of the distance image may be similar to the above descriptions of FIGS. 1 and 2.

The image filtering unit 405 may produce the above-described object image using the facial area detected by the facial area detecting unit 403 and the distance image acquired by the distance image acquiring unit 404. For example, the image filtering unit 405 may identify an area in the distance image corresponding to the detected facial area, calculate a distance to the object using the distance information of the distance image corresponding to the facial area, and then remove a portion corresponding to the background other than the object. If the calculated distance to the object is d, a distance image consisting of distances greater than d−th and smaller than d+th may be used as the object image. Here, the thresholds d−th and d+th denote previously determined threshold values.

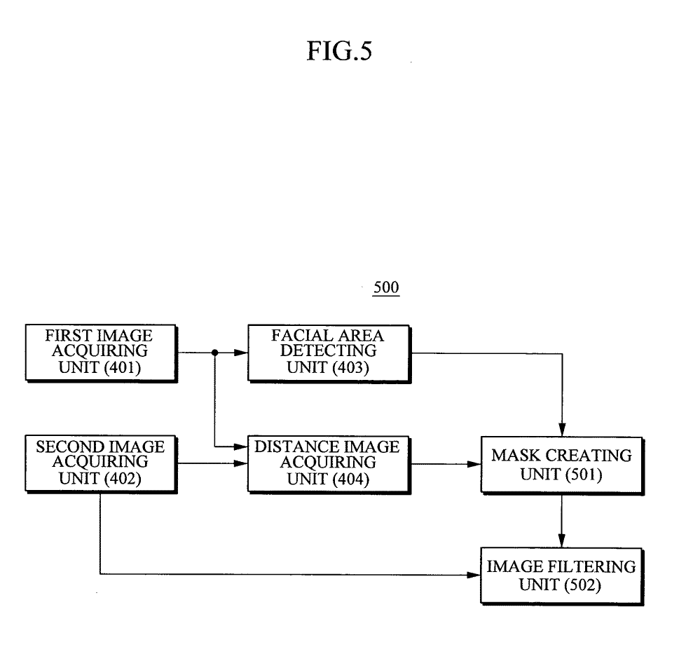

FIG. 5 is a block diagram of an object image acquiring unit, according to one or more embodiments.

In FIG. 5, an object image acquiring unit 500 may include a first image acquiring unit 401, a second image acquiring unit 402, a facial area detecting unit 403, a distance image acquiring unit 404, a mask creating unit 501, and an image filtering unit 502, for example.

The first image acquiring unit 401, the second image acquiring unit 402, the facial area detecting unit 403, and the distance image acquiring unit 404 may be similar to those illustrated in FIG. 4, and accordingly further discussion will not be set forth.

The mask creating unit 501 creates a filtering mask using a facial area detected by the facial area detecting unit 403 and a distance image acquired by the distance image acquiring unit 404. For example, the mask creating unit 501 may identify an area in the distance image corresponding to the detected facial area, calculate the distance to the object using the distance information of the distance image corresponding to the facial area, and then remove a portion corresponding to the background other than the object. If the calculated distance to the object is d, a portion corresponding to a distance greater than d−th and smaller than d+th may be set to 1 and other portions are set to 0 to create the filtering mask. Here, again, the thresholds d−th and d+th denote previously determined threshold values.

The image filtering unit 502 may mask the R image with the created filtering mask to produce the above-described object image.

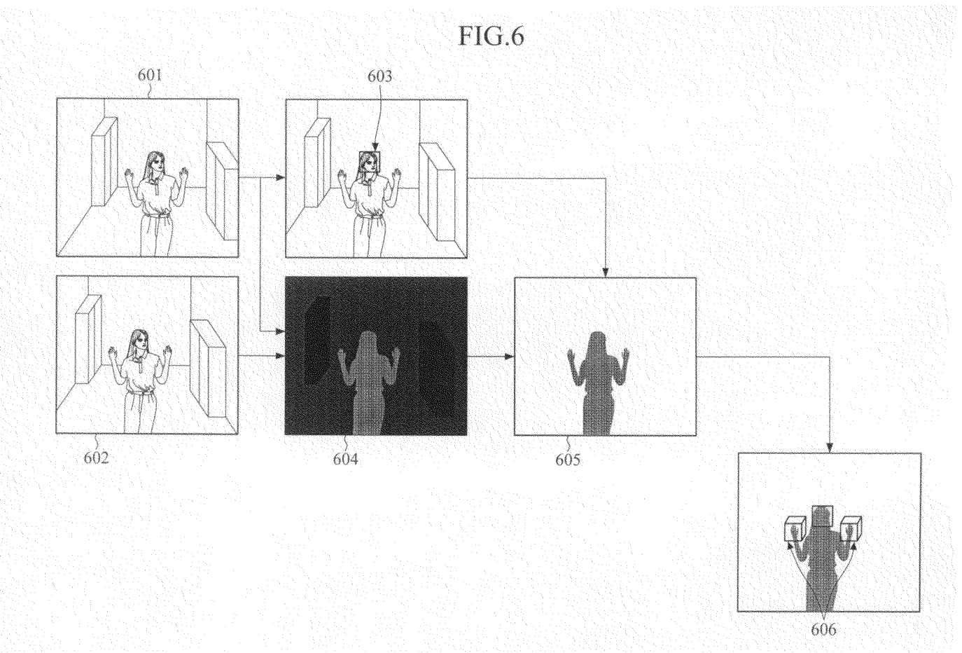

FIG. 6 illustrates an operation of a motion detection method, according to one or more embodiments.

Referring to FIG. 6, the first image acquiring unit 401 and the second image acquiring unit 402 acquire an L image 601 and an R image 602, respectively. In this case, the L image 601 and R image 602 may include both an object and a background.

The facial area detecting unit 403 may detect a facial area 603 from the L image 601.

The distance image acquiring unit 404 may acquire a distance image 604 using the L image 601 and the R image 602.

The image filtering unit 405 may further acquire an object image 605 using distance information of the distance image 604 corresponding to the facial area 603.

When the object image 605 has been acquired, the motion-detection-area setting unit 302 may set a motion detection area 606 in the object image 605. In this case, the motion detection area may be set around a face of the object in the object image 605.

The acquisition of the object image 605 and the setting of the motion detection area 606 may be continuously performed at certain time intervals. That is, through the above-described process, in an embodiment, a first object image with the motion detection area may be acquired at time t₀, and then a second object image with the motion detection area acquired at time t₁.

Thus, here, the motion detecting unit 303 can detect the motion of the object through an amount of an image change in the motion detection area between the first object image and the second object image.

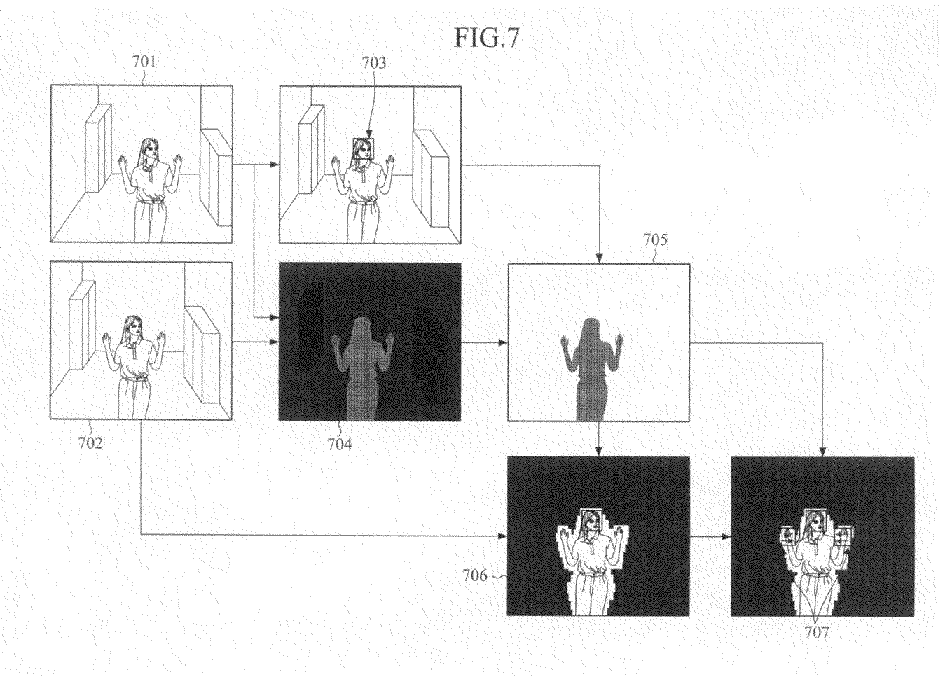

FIG. 7 illustrates an operation of a motion detection method, according to one or more embodiments.

Referring to FIG. 7, the first image acquiring unit 401 and the second image acquiring unit 402 may acquire an L image 701 and an R image 702, respectively. In this case, the L image 701 and R image 702 may include both an object and a background.

The facial area detecting unit 403 may detect a facial area 703 from the L image 701.

The distance image acquiring unit 404 may acquire a distance image 704 using the L image 701 and the R image 702.

The mask creating unit 501 may create an image mask 705 using distance information of the distance image 704 corresponding to the facial area 703. For example, the image mask 705 may be a filtering mask in which an area corresponding to the object is set to 1 and other areas are set to 0.

The image filtering unit 502 may further mask the R image 702 with the image mask 705 to produce an object image 706.

When the object image 706 has been acquired, the motion-detection-area setting unit 302 may set a motion detection area 707 in the object image 706. In this case, the motion detection area may be set around a face of the object in the object image 706, for example.

The acquisition of the object image 706 and the setting of the motion detection area 707 may be continuously performed at certain time intervals. That is, through the process as described above, in an embodiment, a first object image with the motion detection may be acquired at time t₀, and then a second object image with the motion detection area acquired at time t₁.

Thus, the motion detecting unit 303 can detect the motion of the object through an amount of an image change in the motion detection area between the first object image and the second object image.

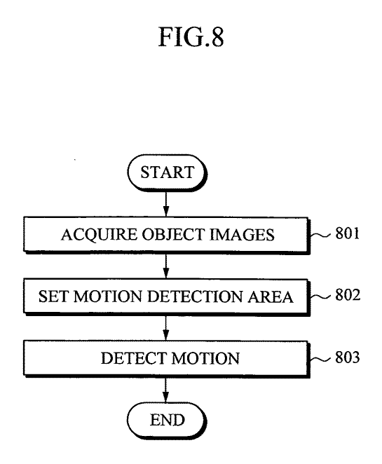

FIG. 8 is a flowchart illustrating a motion detecting method, according to one or more embodiments.

Referring to FIG. 8, first, an object image may be acquired (801). The object image may include only an object by removing a background from any image including the background and the object, and may be obtained through the configuration as shown in FIG. 4 or 5, for example.

A motion detection area may be set in the object image (802). The motion detection area may be a reference area for recognizing an amount of an image change between the object images. For example, the motion detection area may be set around a face of the object image by the motion-detection-area setting unit 302.

The amount of the image change in the motion detection area between the object images may be detected to detect a motion of the object (803). For example, the motion detecting unit 303 can detect the motion of the object through an optical flow between the object images in the motion detection area, a location of a feature point, or a distance change amount, for example.

The detected motion may include a type of the motion. Accordingly, the method may further include generating a predetermined control command according to the type of the detected motion. Various functions of a system using the method of detecting a motion according to one or more embodiments may be controlled according to the control command generated according to the type of the detected motion, for example.

In addition to the above described embodiments, embodiments can also be implemented through computer readable code/instructions in/on a non-transitory medium, e.g., a computer readable medium, to control at least one processing device, such as a processor or computer, to implement any above described embodiment. The medium can correspond to any defined, measurable, and tangible structure permitting the storing and/or transmission of the computer readable code.

The media may also include, e.g., in combination with the computer readable code, data files, data structures, and the like. Examples of computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of computer readable code include both machine code, such as produced by a compiler, and files containing higher level code that may be executed by the computer using an interpreter, for example. The media may also be a distributed network, so that the computer readable code is stored and executed in a distributed fashion. Still further, as only an example, the processing element could include a processor or a computer processor, and processing elements may be distributed and/or included in a single device.

Also, one or more of the above-described embodiments may be applied to air conditioners that recognize a motion of an object to control a blowing direction, e.g., to control a blowing direction of cooled air toward an identified object or person.

While aspects of the present invention has been particularly shown and described with reference to differing embodiments thereof, it should be understood that these embodiments should be considered in a descriptive sense only and not for purposes of limitation. Descriptions of features or aspects within each embodiment should typically be considered as available for other similar features or aspects in the remaining embodiments.

Thus, although a few embodiments have been shown and described, with additional embodiments being equally available, it would be appreciated by those skilled in the art that changes may be made in these embodiments without departing from the principles and spirit of the invention, the scope of which is defined in the claims and their equivalents.

What is claimed is:

1. A motion detecting apparatus, comprising:
an object image acquiring unit to acquire plural object images based on distance information of an object included in images respectively obtained from at least two cameras, the acquired plural object images including the object without a background;
a motion-detection-area setting unit to set respective motion detection areas in the acquired object images; and
a motion detecting unit to detect a motion of the object based on a determined amount of an image change in the respective motion detection areas between the acquired object images.

2. The apparatus of claim 1, wherein the object image acquiring unit comprises:
a first image acquiring unit;
a second image acquiring unit;
a facial area detecting unit to detect a facial area from a first image obtained from the first image acquiring unit or a second image obtained from the second image acquiring unit;
a distance image acquiring unit to acquire a distance image from the first and second images; and
an image filtering unit producing an object image using the detected facial area and the acquired distance image.

3. The apparatus of claim 1, wherein the object image acquiring unit comprises:
a first image acquiring unit;
a second image acquiring unit;
a facial area detecting unit to detect a facial area from a first image obtained from the first image acquiring unit or a second image obtained from the second image acquiring unit;
a distance image acquiring unit to acquire a distance image from first and second images;
a mask creating unit to create an image mask using the detected facial area and the acquired distance image; and
an image filtering unit to produce an object image from the first image or second images based on the created image mask.

4. The apparatus of claim 1, wherein the respective motion detection areas are set around a face of the object.

5. The apparatus of claim 1, wherein the image change amount is defined as an optical flow between the images respectively obtained from the at least two cameras, or a location of a feature point or a distance change amount.

6. A method of detecting motion, comprising:
acquiring plural object images based on distance information of an object included in respective images obtained from at least two cameras, the acquired plural object images including the object without a background;
setting respective motion detection areas in the acquired object images; and
detecting a motion of the object based on a determined amount of an image change in the respective motion detection areas between the acquired object images.

7. The method of claim 6, wherein the acquiring of the object images comprises:
detecting a facial area from an image obtained from one of the at least two cameras;
acquiring a distance image from the images obtained from the at least two cameras; and
producing an object image using the detected facial area and the acquired distance image.

8. The method of claim 7, wherein the producing of the object image comprises filtering the distance image through distance information of the detected facial area.

9. The method of claim 6, wherein the acquiring of the object images comprises:
detecting a facial area from an image obtained from one of the at least two cameras;
acquiring a distance image from the images obtained from the at least two cameras;
creating an image mask using the detected facial area and the acquired distance image; and
producing an object image from the image obtained from the one of the at least two cameras using the created image mask.
